(19) United States
(12) Patent Application Publication
(10) Pub. No.: US 2023/0279267 A1
(43) Pub. Date: Sep. 7, 2023

(54) HIGH TEMPERATURE RESISTANT BINDER

(71) Applicant: MATERION PRECISION OPTICS (SHANGHAI) LIMITED, Pudong, Shanghai (CN)

(72) Inventors: Wenbo Zhang, Shanghai (CN); Ansheng Liang, Pudong, Shanghai (CN)

(21) Appl. No.: 18/018,941

(22) PCT Filed: Sep. 30, 2020
(86) PCT No.: PCT/CN2020/119443

§ 371 Date: Jan. 31, 2023

(51) Int. Cl. C09J 1/00; C09J 11/06; C09J 9/00

(52) U.S. Cl. CPC C09J 1/00; C09J 11/06; C09J 9/00

(57) ABSTRACT

Disclosed is an inorganic binder made with silica sol-gel, and a method of manufacturing the inorganic binder. Techniques and systems are disclosed for using the inorganic binder in light conversion systems, including phosphor wheels. Phosphor wheels with the inorganic binder are capable of withstanding high temperatures, have a highlight transmittance, have a high tensile-shear strength, can be applied by a flexible coating process, and have a low curing temperatures.

### BACKGROUND

The present disclosure relates to inorganic binders that possess certain characteristics that make them suitable for use in optical light conversion devices, such as phosphor wheels, used in such systems. The inorganic binders of the present disclosure maintain an enhanced bonding strength at temperatures up to 250° C.

Organic adhesives (e.g., epoxy, polyurethane, silicone) are widely used for bonding. For example, in a phosphor-in-silicone product, phosphor powder is mixed into a silicone binder or adhesive, then dispensed or printed in the desired pattern. Silicone is popular for the bonding of metal, glass, and other materials due to its high transparency, high bonding strength, lower refractive index, and proper viscosity. However, silicone binders/adhesives have poor thermal stability. At temperatures over 200° C., silicone adhesives will degrade, begin to turn yellow, and gradually begin to burn. In applications with high brightness (e.g., laser power of 200 W), the operating temperature of the phosphor wheel is expected to be generally more than 200° C., thus making the use of silicone adhesive undesirable.

It would therefore be desirable to provide an inorganic binder that exhibits the same desirable characteristics of organic binders (i.e., high transparency, high bonding strength, low refractive index, and proper viscosity), in addition to a higher temperature resistance (e.g., up to 250° C.). Such inorganic binders could advantageously be employed in a variety of applications, such as light tunnels, projection display systems, and optical light conversion devices, such as phosphor wheels, used in such systems.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Disclosed are inorganic binders that can be used in high reflectivity coatings for an optical light conversion device (e.g., a phosphor wheel) or as an adhesive used to join two elements. The inorganic binders possess certain characteristics that make them particularly suitable for use in high-power lighting systems. For example, in particular embodiments, the inorganic binders are capable of withstanding high temperatures (e.g., up to 250° C.), have a high light transmittance (e.g., at least 92%), have a high tensile-shear strength (e.g., at least 100 psi at 250° C.), can be applied by a flexible coating process (e.g., dispensing, silk printing, spraying), and have a low curing temperature (e.g., less than 200° C.).

In one exemplary embodiment, an inorganic binder is provided, the inorganic binder comprising a silica sol-gel solution, the silica sol-gel solution comprising silica sol-gel and water, a silane coupling agent, an alcohol-soluble solvent, and fillers.

In another exemplary embodiment, a method of manufacturing an inorganic binder is provided, the method comprising adding alcohol-soluble solvent and a silane coupling agent to a container, and mixing the alcohol-soluble solvent and the silane coupling agent, forming a first solution (e.g., which may or may not be uniform), adding silica-sol gel to the first solution, and mixing the silica-sol gel and the first solution, forming a second solution, adding fillers to the second solution, and mixing the fillers and the second solution until any chemical reactions between the fillers and the second solution are complete, forming a third solution, and removing water from the third solution.

To the accomplishment of the foregoing and related ends, the following description and annexed drawings set forth certain illustrative aspects and embodiments. These are indicative of but a few of the various ways in which one or more aspects may be employed. Other aspects, advantages and novel features of the disclosure will become apparent from the following detailed description when considered in conjunction with the annexed drawings.

### BRIEF DESCRIPTION OF THE DRAWINGS

The claimed matter may take physical form in certain parts and arrangements of parts, a preferred embodiment of which will be described in detail in the specification and illustrated in the accompanying drawings which form a part hereof, and wherein:

FIG. 1 is a flow chart illustration of a method of manufacturing an exemplary embodiment of an inorganic binder.

FIG. 2 is a schematic illustration of an exemplary embodiment of an optical light conversion device that may utilize one of the binders described herein.

FIG. 3 is a side cross-sectional view of the optical light conversion device of FIG. 2, which may use one of the binders described herein.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

With reference to the drawings, like reference numerals designate identical or corresponding parts throughout the several views. However, the inclusion of like elements in different views does not mean a given embodiment necessarily includes such elements or that all embodiments of the claimed subject matter include such elements. The examples and figures are illustrative only and not meant to limit the claimed subject matter, which is measured by the scope and spirit of the claims.

The material of binders/adhesives utilized in light conversion applications directly affect the efficiency and quality of the light conversion. Such materials may be exposed to high temperatures, making the lifetime of a light conversion device directly influenced by the binder's thermal stability. Accordingly, a material that exhibits a high thermal stability, while simultaneously exhibiting other advantageous characteristics, such has a high bonding strength and a high transparency, is desirous for light conversion applications.

Organic binders, such as silicone, epoxy, and polyurethane, are often used in light conversion devices, because of their high transparency and bonding strength. These materials however also exhibit low thermal stability, resulting in materials that degrade, begin to turn yellow, and gradually burn when introduced to temperatures over 200° C. In applications with high brightness (e.g., laser power of about 200 W), the operating temperature of the light conversion device may reach temperatures greater than 200° C., making organic binders undesirable for long-term solutions.

In an exemplary embodiment of the present disclosure, an inorganic binder is provided that is capable of withstanding high temperatures (e.g., greater than 250° C.), has a high light transmittance characteristic (e.g., at least 92%), and has a high tensile-shear strength (e.g., at least 100 psi at 250° C.). In this aspect, in some embodiments, the binder can be applied by a flexible coating process (e.g., dispensing, silk printing, spraying, sputtering), and may have a low curing temperature (e.g., less than 200° C.).

In some embodiments, an exemplary inorganic binder can comprise an acidic, nano colloidal silica, (e.g., a nano silica sol-gel having a PH value of 4-5). Silica sol-gel is an odorless, non-toxic colloid formed using SiO₂ nanoparticles dispersed in water, whose molecular formula is mSiO2·nH2O, and, in this embodiment, comprising a slightly acidic PH value of 4-5.

For example, silica sol-gel can be a good choice to resolve a high temperature resistance problem, because silica sol-gel is an inorganic material that can be cured at temperatures under 200° C. However, silica sol-gel may not be appropriate for use directly as binder, because of its low bonding strength with aluminum, phosphor, glass, ceramics and other target materials. Further, silica sol-gel can easily crack, deform or otherwise display undesired physical properties due to solvent evaporation. Additionally, the elasticity of silica sol-gel is poor compared with organic silicone glue.

In one aspect, as described herein, silica sol-gel can be modified by adding a silane coupling agent and/or other fillers to improvement bonding stability and physical properties. However, when silane coupling agents and/or other fillers are added to silica sol-gel, the resulting product can have an unstable viscosity, which may be caused by a continuous chemical reaction of the silane coupling agent. Therefore, the viscosity of this sol-gel binder can increase over time going, and/or the sol-gel binder may cure quickly at room temperature and become silica within a short period of time. For example, the silane coupling agent may be comprised of trimethoxy silane, triethoxy silane, tetramethyl silicate, tetraethyl silicate, or a combination thereof.

In this aspect, a desirable silica sol-gel based binder can be developed by adjusting and controlling the PH value, and through appropriate materials selection. For example, a silane coupling agent, such as MTMS [Trimethoxymethylsilane (MTMS) can be a desired precursor for the synthesis of monolithic silica columns with various skeleton sizes for capillary liquid chromatography (e.g., ionogels, where an ionic liquid is confined within silica-derived networks) can be added to the silica sol-gel to improve bonding strength. In this example, with the MTMS added, the resulting sol-gel based binder also illustrates good performance on transmittance and filming-forming property. During production, the PH value can be adjusted to 4-5 to mitigate the unstable viscosity that caused by MSTS and fillers, resulting in a sol-gel glue with a shelf-life of 3-6 months at 4° C. by adjusting PH value, which means the chemical reaction is slowly at room temperature.

In this aspect, however, silica sol-gel binder comprising silane coupling agent can be brittle and easy to crack. In some embodiments, one or more fillers can be added to the sol-gel based binder to improve tenacity of a resulting film. For example, a filler can comprise one or more types, including, but not limited, to Micro/Nano calcium fluoride, Micro/Nano magnesium fluoride, Micro/Nano quartz, Micro/Nano low melting point glass powder, fumed silica, sodium silicate, hydroxy modified polymer resin, hydroxy modified silicone resin, Silane chain extender, hydroxy modified silicone oil, TEOS, and water-soluble polymer resin. Further, the potential issue of low viscosity, or solvent volatility, can be mitigated by using a rotary evaporator and/or adding high boiling point solvent.

In this aspect, for example a resulting product of sol-gel based binder can have improved performance at approximately 250° C. temperature. Further, the viscosity of sol-gel based binder can be more stable, with a high light transmittance, improved filming-forming property, and improved storage life.

In one aspect, as described herein, a solvent may be added to the sol-gel based binder to promote even coverage of the coupling agent within the sol-gel based binder. The resulting sol-gel based binder may have improved adherence strength. The solvent may be anything suitable, such as an alcohol-soluble solvent. In some embodiments, the alcohol-soluble solvent is ethanol, isopropyl alcohol, ethylene glycol, propylene glycol, or a combination thereof.

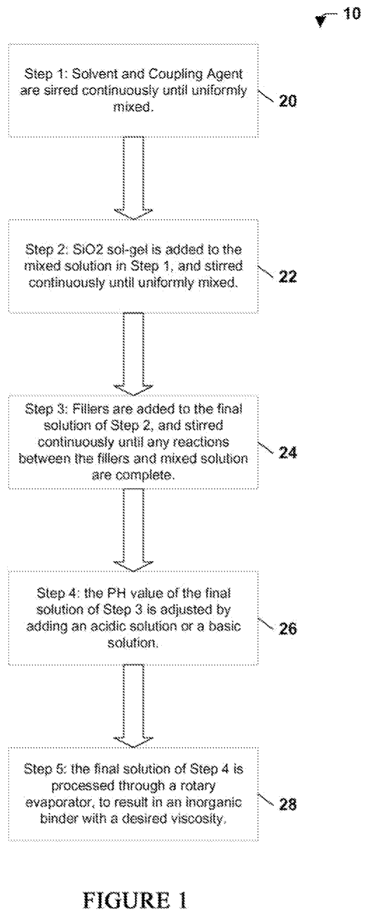

Referring to FIG. 1, the inorganic binder may be manufactured in a series of steps shown at 10. In one embodiment, as shown at 20, a proportion of 0 grams-1000 grams of solvent and a proportion of 0.5 grams-1000 grams of coupling agent may be mixed in a container. The mixing may take place at temperatures of about 4° C.-about 20° C., preferably at 10° C.-about 20° C., for about 2 minutes-30 minutes. In some implementations, the solution can be mixed at least until the solution is a homogenous mixture of solvent and coupling agent. However, in other implementations, the solution may merely be mixed for a desired amount of time for the desired result of the solution, regardless of whether the solution is homogeneous or not. It should be appreciated that the time and temperature may be adjusted based on the amounts and types of solvent and coupling agent. For example, the solvent may comprise one or more of low boiling point (e.g., <150 C) solvents such as water, ethanol, isopropyl alcohol; and high boiling point solvents (e.g., >150 C) such as ethylene glycol and propylene glycol. Additionally, as an example, the coupling agent can comprise one or more of tetramethyl silicate, tetraethyl silicate, group of trimethoxy silane, group of triethoxy silane.

Further, in this example method of binder production, as shown at 22, a proportion of about 100 grams of acidic nano silica sol-gel, having a PH value of 4-5, such as Yuda Chemical's HS-25, or LUDOX′ HAS colloidal silica, may be added to the solution of solvent and coupling agent. The silica sol-gel may be mixed with the solution of solvent and coupling agent, at a temperature of about 4° C.-about 20° C., preferably at 10° C.-about 20° C., for about 1 hour to about 3 hours. It should be appreciated that the time and temperature may be adjusted based on the amounts and types of solvent, coupling agent, and silica sol-gel.

Additionally, as shown at 24, fillers may be added to the mixed solvent, coupling agent, and silica sol-gel solution. As an example, a filler can comprise one or more of Micro/Nano calcium fluoride, Micro/Nano magnesium fluoride, Micro/Nano quartz, Micro/Nano low melting point glass powder, fumed silica (e.g., produced in flame, micro droplets of amorphous silica fused into branches that agglomerate to larger particles), sodium silicate, hydroxy modified polymer resin, hydroxy modified silicone resin, Silane chain extender, hydroxy modified silicone oil, TEOS [Tetraethyl orthosilicate, formally named tetraethoxysilane, formula Si(OC2H5)4, is a colorless liquid that degrades in water), and water-soluble polymer resin. After a proportion of 0 grams-500 grams of filler is added, the solution of solvent, coupling agent, silica sol-gel, and filler may be mixed at a temperature of about 4° C.-about 20° C., preferably at 10° C.-about 20° C., for about 2 hours to about 48 hours, at least until the fillers react substantially completely with the solution to form a precursor of the inorganic binder. It should be appreciated that the time and temperature may be adjusted based on the amounts and types of solvent, coupling agent, silica sol-gel, and filler, and the desired condition and/or consistency of the resulting precursor.

In this embodiment as shown at 28, the precursor solution may be tested by any suitable means for the PH value, and may be adjusted, if needed, to meet the 4-5 PH value, for example by adding an acid or base to the solution. An acid is a solution with a PH less than 7, and a base is a solution with a PH greater than 7. In one example, if the PH value is greater than about 4.5, a base may be added, such as sodium hydroxide (NaOH), until the PH value of the solution reaches about 4.5. If the PH value of the solution is less than about 4.5, an acid may be added, such as hydrochloric acid (HCl), until the PH value of the solution reaches about 4.5.

In some embodiments, a rotary evaporator equipment may be used to facilitate removal of at least some of the added solvent in the inorganic binder 222. As an example, a rotary evaporator removes solvents from a solution by evaporation. In some embodiments, the rotary evaporator equipment may be used to remove solvents with a low boiling point (e.g., less than 150° C.) from the inorganic binder. The removal of the solvent, for example, can result in an inorganic binder with a desired viscosity, such as to allow appropriate application of the finder, mitigate settling of a binder target material, and provide for stability of the applied binder.

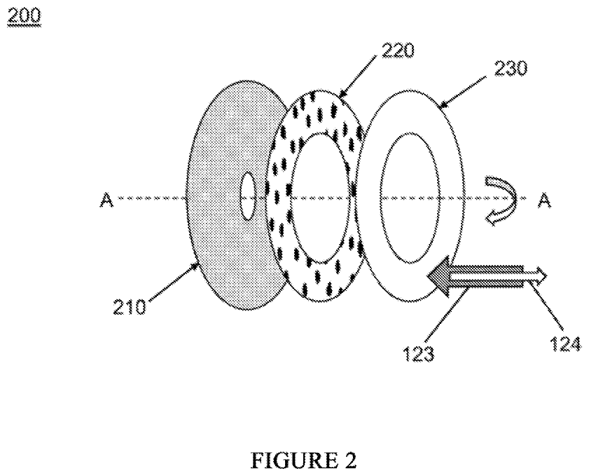

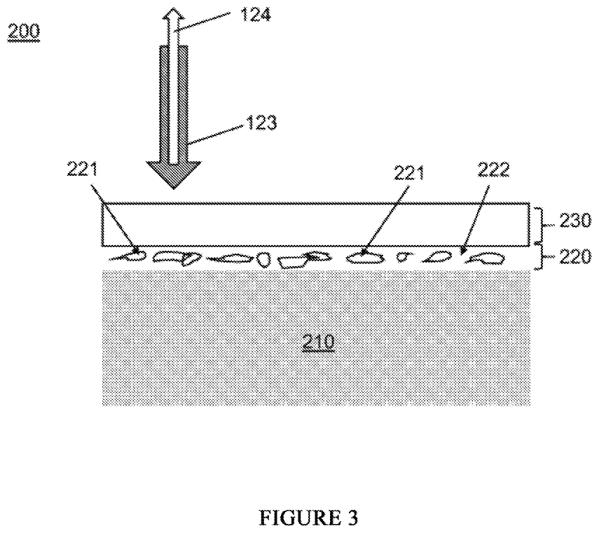

Referring to FIG. 2 and FIG. 3, a light conversion device 200 is provided that utilizes an inorganic binder for converting excitation light 123 into emission light 124. The excitation light 123, is input light, or light produced from a laser-based illumination source or other light source. The excitation light 123 is transmitted from a light source and directed towards the light conversion device 200, which converts the excitation light 123 into the emission light 124 by converting the wavelength of the excitation light 123, into the wavelength of the emission light 124, and then reflecting the emission light 124 back towards the source of the excitation light 123. Because the emission light 124 has a different wavelength than the excitation light 123, the emission light 123 has a different color than the excitation light 124.

For example, a blue light laser, having a wavelength of about 440 nm-about 460 nm, may be used as a light source. When the blue light is exposed to the light conversion device 200 as excitation light 123, the resulting emission light may be red (light having a wavelength of about 780 nm-about 622 nm), green (light having a wavelength of about 577 nm-492 nm), or yellow (light having a wavelength of about 597 nm-about 577 nm).

As excitation light 123 hits the light conversion device 200, the temperature of the light conversion device 200 rises. Under normal operating conditions, approximately 50%-60% of the excitation light 123 is converted to heat, while the rest is converted into emission light 124. In applications where the excitation light 123 has high levels of brightness (e.g., laser power of 200 W), the light conversion device 200 may reach temperatures of more than 200° C. At these temperatures, light conversion devices having poor thermal stability begin to degrade, turn yellow, and gradually begin to burn. This effects the strength of the emission light 124, the color quality, and the lifetime of the light conversion device 200.

In some embodiments of the present disclosure, a light conversion device 200 having a high thermal stability is provided. The light conversion device 200 contains three layers: a substrate 210, a reflective layer 220, and a phosphor layer 230. The reflective layer 220 is located between the substrate 210, and the phosphor layer 230. When exposed to the excitation light 123, phosphors in the phosphor layer 230 are excited and produce the emission light 124. The emission light 124 is then reflected off the reflective layer 220.

In some embodiments, the substrate 210 of the light conversion device 200 is a metal having a high thermal conductivity, such as aluminum or an aluminum alloy, copper or a copper alloy, or another metal having a high thermal conductivity. The substrate 210 may also be made of glass, sapphire, or diamond. The substrate 210 has opposing surfaces, at least one of such surfaces having a surface that may be bound to the reflective layer 220.

The reflective layer 220 is dispersed, sprayed, or silk printed directly onto the surface of the substrate 210. In some embodiments, the reflective layer 220 is made with refractive particle(s) 221, a solvent(s), and inorganic binder(s) 222. The refractive particles 221 may have a size of about 0.1 μm-about 150 μm, and may be made from anything suitable, such as titanium oxide (TiO₂). The solvent may be made from anything suitable, such as propylene glycol. In some embodiments, the ratio of refractive particle(s) 221, solvent(s), and inorganic binder(s) 222 is 5:1:2. The reflective layer 220 has opposing surfaces, one bound to the substrate 210, and one that may be bound to the phosphor layer 230.

In other embodiments, the reflective layer 220 is sprayed directly onto the substrate 210 in a series of steps. The desired amounts of refractive particle(s) 221, solvent(s), and inorganic binder(s) 222 are first mixed to form a mixture. The mixture is then sprayed onto the substrate in a first layer, and rests at a temperature of 60° C. for about 30 minutes. Next, the first layer is cured at about 150° C. for about 20 minutes. A second layer of the mixture is then applied by spraying the mixture onto the first layer. The second layer is step cured, first at a temperature of about 60° C. for about 30 minutes, then at a temperature of about 150° C. for about 20 minutes, and lastly at a temperature of about 180° C. for about 1 hour.

The phosphor layer 230 is dispersed or silk printed directly on the surface of the reflective layer 220. In some embodiments, the phosphor layer is made of phosphor powder(s), solvent(s), dispersant(s), and inorganic binder(s). The phosphor powder may be made of phosphors having a particles size of about 10 μm-about 30 μm, and may be made of anything suitable, such as yttrium aluminum garnet (YAG), silicate, and nitride. The solvent may be made of anything suitable, such as propylene glycol. The dispersant may be made of anything suitable, such as fumed silica, or the like. In some embodiments, the ratio of phosphor powder(s), solvent(s), dispersant(s), and inorganic binder(s) is 10:1:0.3:3.

In other embodiments, the phosphor layer 230 is silk printed directly onto the reflective layer 220 in a series of steps. The desired amounts of phosphor powder(s), dispersant(s), thickening agent(s), and inorganic binder(s) are first mixed to form a mixture. The mixture is then silk printed onto the reflective layer 220. The mixture is step cured, first at a temperature of about 150° C. for about 20 minutes, and lastly at a temperature of about 180° C. for about 1 hour.

All references, including publications, patent applications, and patents, cited herein, are hereby incorporated by reference in their entirety and to the same extent as if each reference were individually and specifically indicated to be incorporated by reference and were set forth in its entirety herein (to the maximum extent permitted by law), regardless of any separately provided incorporation of particular documents made elsewhere herein.

Unless otherwise stated, all exact values provided herein are representative of corresponding approximate values (e.g., all exact exemplary values provided with respect to a particular factor or measurement can be considered to also provide a corresponding approximate measurement, modified by “about,” where appropriate). All provided ranges of values are intended to include the end points of the ranges, as well as values between the end points.

The citation and incorporation of patent documents herein is done for convenience only and does not reflect any view of the validity, patentability, and/or enforceability of such patent documents.

The inventive concepts described herein include all modifications and equivalents of the subject matter recited in the claims and/or aspects appended hereto as permitted by applicable law.

1. An inorganic binder comprising:
a silica sol-gel solution, the silica sol-gel solution including silica sol-gel and water;
a silane coupling agent;
an alcohol-soluble solvent; and
at least one filler.

2. The inorganic binder of 1, wherein the silica sol-gel is nano acidic and has a PH value of about 4-5.

3. The inorganic binder of claim 1, wherein the silane coupling agent is comprised of one or more of trimethoxy silane, triethoxy silane, tetramethyl silicate, and tetraethyl silicate.

4. The inorganic binder of claim 1, wherein the alcohol-soluble solvent is comprised one or more of water, ethanol, isopropyl alcohol, ethylene glycol, and propylene glycol.

5. The inorganic binder of claim 1, wherein the at least one of is comprised of one or more of hydroxyl modified silicone resin, hydroxyl modified polymer resin, micro/nano calcium fluoride, micro/nano magnesium fluoride, micro/nano quartz, micro/nano low melting point glass powder, fumed silica, sodium silicate, silane chain extender, hydroxyl modified silicone oil, tetraethyl orthosilicate, and water-soluble polymer resin.

6. The inorganic binder of claim 1, wherein the silica sol-gel solution, silane coupling agent, alcohol-soluble solvent, and fillers have a PH value of about 4.5.

7. A method of manufacturing an inorganic binder comprising:
adding alcohol-soluble solvent and a silane coupling agent to a container, and mixing the alcohol-soluble solvent and the silane coupling agent, forming a first solution;
adding silica-sol gel to the first solution, and mixing the silica-sol gel and the first solution, forming a second solution;
adding one or more fillers to the second solution, and mixing the one or more fillers and the second solution until any chemical reactions between the one or more fillers and the second solution are complete, forming a third solution; and
removing excess water from the third solution.

8. The method of claim 7, wherein the alcohol-soluble solvent and the silane coupling agent are mixed at temperatures of about 4° C. to about 20° C. for a period of about 2 minutes to about 30 minutes.

9. The method of claim 7, wherein the silica sol-gel and first solution are mixed at temperatures of about 4° C. to about 20° C. for a period of about 1 hour to about 3 hours.

10. The method of claim 7, wherein the one or more fillers and second solution are mixed at temperatures of about 4° C. to about 20° C. for a period of about 2 hours to about 48 hours.

11. The method of claim 7, wherein the silica sol-gel is nano acidic and has a PH value of about 4-5.

12. The method of claim 7, wherein the silane coupling agent is comprised of one or more of trimethoxy silane, triethoxy silane, tetramethyl silicate, and tetraethyl silicate.

13. The method of claim 7, wherein the alcohol-soluble solvent is comprised of one or more of water, ethanol, isopropyl alcohol, ethylene glycol, and propylene glycol.

14. The method of claim 7, wherein the one or more fillers is comprised of one or more of hydroxyl modified silicone resin, hydroxyl modified polymer resin, micro/nano calcium fluoride, micro/nano magnesium fluoride, micro/nano quartz, micro/nano low melting point glass powder, fumed silica, sodium silicate, silane chain extender, hydroxyl modified silicone oil, tetraethyl orthosilicate, and water-soluble polymer resin.

15. The method of claim 7, wherein prior to removing excess water from the third solution, the PH of the third solution is tested and adjusted to a value of 4.5.

16. The method of claim 8, wherein the alcohol-soluble solvent and the silane coupling agent are mixed at temperatures of about 10° C. to about 20° C. for the period of about 2 minutes to about 30 minutes.

17. The method of claim 9, wherein the silica sol-gel and first solution are mixed at temperatures of about 10° C. to about 20° C. for the period of about 1 hour to about 3 hours.

18. The method of claim 10, wherein the one or more fillers and second solution are mixed at temperatures of about 10° C. to about 20° C. for the period of about 2 hours to about 48 hours.
